(19) United States
(12) Patent Application Publication
(10) Pub. No.: US 2026/0335809 A1
(43) Pub. Date: Oct. 29, 2026

(54) WASH DESIGN FOR VOLATILE ORGANIC COMPOUND CONTROL

(71) Applicant: ION Clean Energy, Inc., Boulder, CO (US)

(72) Inventors: Nathan A. Fine, Westminster, CO (US); Erik Everhardus Bernardus Meuleman, Boulder, CO (US); Kenneth K. Jew, Boulder, CO (US)

(73) Assignee: ION Clean Energy, Inc., Boulder, CO (US)

(21) Appl. No.: 19/188,207

(22) Filed: Apr. 24, 2025

(51) Int. Cl. B01D 53/14; B01D 53/18; B01D 53/62; B01D 53/78

(52) U.S. Cl. CPC B01D 53/1406; B01D 53/1475; B01D 53/1487; B01D 53/185; B01D 53/62; B01D 53/78; B01D 2252/103; B01D 2252/204; B01D 2257/504; B01D 2257/708; B01D 2258/0283

(57) ABSTRACT

Techniques for utilizing wire gauze packing in a volatile organic compound (VOC) control wash, of a solvent-based carbon capture system, having a (e.g., low) recirculation rate are described. As a CO₂-lean flue gas stream passes (e.g., rises) through the VOC control wash, it is contacted with a solution to remove VOCs that have been vaporized into the flue gas stream. The VOC control wash may have a wire gauze packing, low recirculation rate, low liquid wetted rate, and high flue gas load factor.

### GOVERNMENT INTEREST

The present disclosure was made with Government support under Grant No. DE-FE 0031950 awarded by the Department of Energy. The Government has certain rights in the present disclosure.

### BACKGROUND

Designs for recirculating volatile organic compound (VOC) control washes, in carbon capture systems, use structured packings made out of sheet metal. This packing is easier to manufacture and more cost effective than wire gauze packing.

Generally, the wetted rates achieved in recirculating VOC control washes are considered acceptable for commercially available sheet metal structured packings, making them the mass transfer equipment of choice for solvent-based carbon capture technologies. However, the use of commercially available sheet metal structured packings in VOC control washes having low recirculation flows results in poor mass transfer performance.

### SUMMARY

A first aspect of the present disclosure relates to a method for treating a flue gas stream, comprising: contacting a CO₂-rich flue gas stream with a CO₂ absorbent to produce a CO₂-lean flue gas stream; passing the CO₂-lean flue gas stream through a wire gauze packing of a volatile organic compound (VOC) control wash at a flue gas load factor in a range of

$$1. to 4. ( \frac{ft}{s} ) {( \frac{lb}{{ft}^{3}} )}^{0.5} ;$$

and inputting feed solution to the VOC control wash at a rate of no more than 1.5 gpm/ft², wherein the feed solution comprises a recirculated portion and a non-recirculated portion, the recirculated portion being a portion of process solution output from the VOC control wash.

In some embodiments of the first aspect, the method further comprises inputting the feed solution at a rate of no more than 1.0 gpm/ft².

In some embodiments of the first aspect, the method further comprises inputting the feed solution at a rate of no more than 0.4 gpm/ft².

In some embodiments of the first aspect, the method further comprises inputting the feed solution at a rate in the range of 0.02 to 1.5 gpm/ft².

In some embodiments of the first aspect, the method further comprises inputting the feed solution at a rate in the range of 0.1 to 1.0 gpm/ft².

In some embodiments of the first aspect, the method further comprises inputting the feed solution at a rate in the range of 0.05 to 0.4 gpm/ft².

In some embodiments of the first aspect, the method further comprises producing the feed solution by combining the recirculated portion with the non-recirculated portion, wherein the combining comprises providing the recirculated portion at a lower gpm than the non-recirculated portion.

In some embodiments of the first aspect, the method further comprises producing the feed solution to have a ratio of the recirculated portion to the non-recirculated portion in the range of 1:100 to 1:1 gpm:gpm.

In some embodiments of the first aspect, the method further comprises producing the feed solution to have a ratio of the recirculated portion to the non-recirculated portion in the range of 1:20 to 1:5 gpm:gpm.

In some embodiments of the first aspect, the method further comprises producing the feed solution to have a ratio of the recirculated portion to the non-recirculated portion of no more than 1:10 gpm:gpm.

In some embodiments of the first aspect, the method further comprises producing the non-recirculated portion from water output from a water wash.

In some embodiments of the first aspect, the method further comprises inputting, to a water wash, CO₂-lean flue gas stream output from the VOC control wash.

A second aspect of the present disclosure relates to a system for treating a flue gas stream, comprising a volatile organic compound (VOC) control wash that: comprises a wire gauze packing; receives a CO₂-lean flue gas stream at a flue gas load factor in a range of

$$1. to 4. ( \frac{ft}{s} ) {( \frac{lb}{{ft}^{3}} )}^{0.5} ,$$

wherein the CO₂-lean flue gas stream is produced from contacting a CO₂-rich flue gas stream with a CO₂ absorbent; and receives feed solution at a rate of no more than 1.5 gpm/ft², wherein the feed solution comprises a recirculated portion and a non-recirculated portion, the recirculated portion being a portion of process solution output from the VOC control wash.

In some embodiments of the second aspect, the VOC control wash receives the feed solution at a rate of no more than 1.0 gpm/ft².

In some embodiments of the second aspect, the VOC control wash receives the feed solution at a rate of no more than 0.4 gpm/ft².

In some embodiments of the second aspect, the VOC control wash receives the feed solution at a rate in the range of 0.02 to 1.5 gpm/ft².

In some embodiments of the second aspect, the VOC control wash receives the feed solution at a rate in the range of 0.1 to 1.0 gpm/ft².

In some embodiments of the second aspect, the VOC control wash receives the feed solution at a rate in the range of 0.05 to 0.4 gpm/ft².

In some embodiments of the second aspect, the recirculated portion is provided at a lower gpm than the non-recirculated portion.

In some embodiments of the second aspect, a ratio of the recirculated portion to the non-recirculated portion is in the range of 1:100 to 1:1 gpm:gpm.

In some embodiments of the second aspect, the ratio of the recirculated portion to the non-recirculated portion is in the range of 1:20 to 1:5 gpm:gpm.

In some embodiments of the second aspect, a ratio of the recirculated portion to the non-recirculated portion is no more than 1:10 gpm:gpm.

In some embodiments of the second aspect, the system further comprises a water wash that outputs the non-recirculated portion of the feed solution.

In some embodiments of the second aspect, the system further comprises a water wash that receives CO₂-lean flue gas stream output from the VOC control wash.

A third aspect of the present disclosure relates to a volatile organic compound (VOC) control wash of a system for treating a flue gas stream, the VOC control wash comprising: a wire gauze packing; a first inlet that receives a CO₂-lean flue gas stream at a flue gas load factor in a range of

$$1. to 4. ( \frac{ft}{s} ) {( \frac{lb}{{ft}^{3}} )}^{0.5} ,$$

wherein the CO₂-lean flue gas stream is produced from contacting a CO₂-rich flue gas stream with a CO₂ absorbent; a second inlet that receives feed solution at a rate of no more than 1.5 gpm/ft², wherein the feed solution comprises a recirculated portion and a non-recirculated portion; and an outlet through which process solution is output from the VOC control wash, wherein at least a portion of the process solution forms the recirculated portion.

In some embodiments of the third aspect, the second inlet receives the feed solution at a rate of no more than 1.0 gpm/ft².

In some embodiments of the third aspect, the second inlet receives the feed solution at a rate of no more than 0.4 gpm/ft².

In some embodiments of the third aspect, the second inlet receives the feed solution at a rate in the range of 0.02 to 1.5 gpm/ft².

In some embodiments of the third aspect, the second inlet receives the feed solution at a rate of 0.1 to 1.0 gpm/ft².

In some embodiments of the third aspect, the second inlet receives the feed solution at a rate in the range of 0.05 to 0.4 gpm/ft².

In some embodiments of the third aspect, the recirculated portion is provided at a lower gpm than the non-recirculated portion.

In some embodiments of the third aspect, a ratio of the recirculated portion to the non-recirculated portion is in the range of 1:100 to 1:1 gpm:gpm.

In some embodiments of the third aspect, the ratio of the recirculated portion to the non-recirculated portion is in the range of 1:20 to 1:5 gpm:gpm.

In some embodiments of the third aspect, a ratio of the recirculated portion to the non-recirculated portion is no more than 1:10 gpm:gpm.

In some embodiments of the third aspect, the non-recirculated portion is formed from process water output from a water wash.

### BRIEF DESCRIPTION OF DRAWINGS

FIG. 1 is a conceptual diagram of a carbon capture system.

FIG. 2 is a plot of CO₂ absorbent component concentrations at different flue gas temperatures for two different VOC control wash packings.

### DETAILED DESCRIPTION

### Overview

The present disclosure provides techniques for utilizing one or more VOC control washes—having wire gauze packing in a VOC control wash—in a solvent-based carbon capture system having a (e.g., low) recirculation rate. As CO₂-lean flue gas stream passes (e.g., rises) through the VOC control wash(es), it is contacted with water (and/or other liquids) to remove VOCs that have been vaporized into the flue gas stream. Some embodiments of the present disclosure utilize a VOC control wash(es) having a wire gauze packing, low recirculation rate, low liquid wetted rate, and high flue gas load factor.

As detailed herein, wire gauze packing is significantly more effective than structured packing for recirculating VOC control wash performance. This is especially observed at lower recirculation rates (e.g., where wetted rates are between 0.1 and 1.5 gallons per minute (gpm)/ft²). While these wetted rates are generally on the low end but acceptable in the commercial literature for sheet metal structured packing, testing has demonstrated that wire gauze packing performs unexpectedly well in VOC control wash applications at low liquid wetted rates and high flue gas load factor.

One advantage of the present disclosure is the ability to operate a VOC control wash (or multiple VOC control washes) at lower recirculation rates while maintaining sufficient wetting of the wire gauze packing. This in turn allows for better equilibrium conditions at the top section of the VOC control wash, which lowers solvent vapor (e.g., carryover into a next VOC control wash).

The teachings of the present disclosure can reduce emissions of carbon capture absorbent components out of absorber VOC control washes by one to two orders of magnitude.

As used herein, “flue gas” or “flue gas stream” refers to carbon-containing (e.g., CO₂-containing) gas (stream) that may (but need not) result from hydrocarbon combustion. The CO₂ content of a CO₂-rich flue gas stream may (but need not) be in the range of from 3 vol % to 30 vol %.

While the present disclosure describes the capturing of CO₂ from a flue gas stream, the teachings of the present disclosure may be used to capture other acid gases (e.g., H₂S or SOₓ) together with CO₂, which may be present in a flue gas stream from combustion of hydrocarbons from specific geological sources.

In some embodiments, a flue gas stream may contain significant concentrations of oxygen gas (O₂) not consumed during the combustion process. As such, a flue gas stream may be dehumidified (i.e., the flue gas stream may be cooled following combustion to condense primarily water, and other condensable components, from the flue gas stream). Such a dehumidified flue gas stream may contain a significant concentration of 02, for example at least 0.5 vol %, at least 2 vol %, at least 4 vol %, or even at least 6 vol %, although 02 concentration may often be no larger than 21 vol %.

### Carbon Capture System

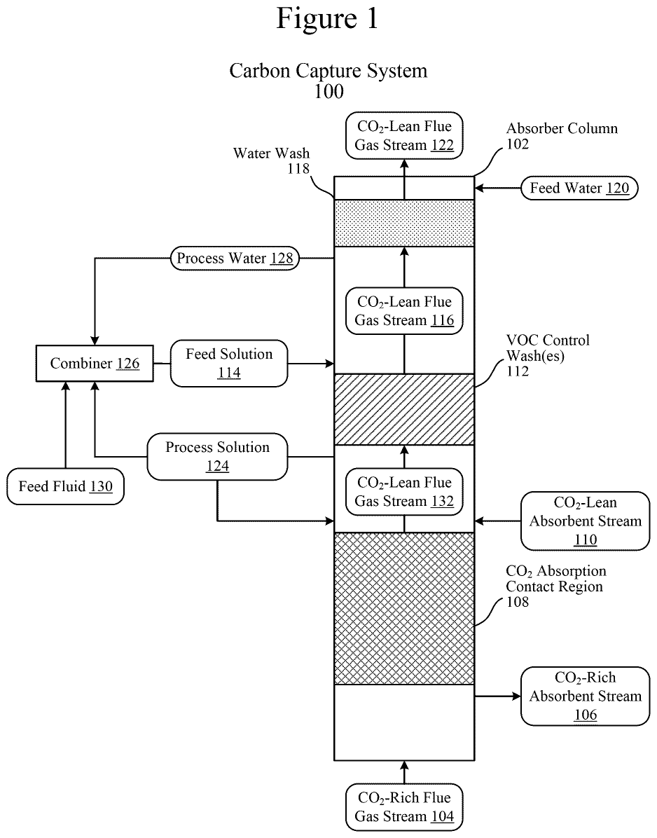

As illustrated in FIG. 1, a carbon capture system (100) of the present disclosure includes an absorber column (102) for absorbing CO₂ from a CO₂-rich flue gas stream (104). In some embodiments, the CO₂ content of the CO₂-rich flue gas stream (104) may (but need not) be in the range of from 3 vol % to 30 vol %. The CO₂-rich flue gas stream (104) enters the absorber column (102) [e.g., below a CO₂ absorption contact region (108)] and travels (e.g., vertically upward) through the CO₂ absorption contact region (108) of the absorber column (102). A CO₂-lean absorbent stream (110) is input to the absorber column (102) [e.g., above the CO₂ absorption contact region (108)]. As the CO₂-lean absorbent stream (110) moves (e.g., vertically downward) through the CO₂ absorption contact region (108) and the CO₂-rich flue gas stream (104) simultaneously moves (e.g., vertically upward) through the CO₂ absorption contact region (108), the CO₂-lean absorbent stream (110) becomes a CO₂-rich absorbent stream (106) by absorbing some, substantially all, or all of the CO₂ from the CO₂-rich flue gas stream (104).

The CO₂-lean absorbent stream (110) may include one or more amine-containing compounds capable of absorbing CO₂ from the CO₂-rich flue gas stream upon contact.

Within the CO₂ absorption contact region (108), the CO₂-lean absorbent stream (110) may come into contact with the CO₂-rich flue gas stream (104) via spraying of the CO₂-lean absorbent stream (110). In some embodiments, the CO₂ absorption contact region (108) may include flow diversion barriers configured to alter the flow of the CO₂-rich flue gas stream (104) and increase contact of the CO₂-rich flue gas stream (104) with the CO₂-lean absorbent stream (110).

The CO₂-rich absorbent stream (106) is output from the absorber column (102). While not illustrated, in some embodiments the carbon capture system (100) may include a desorption reactor. In the desorption reactor, the CO₂-rich absorbent stream (106) may be processed to desorb the CO₂ therefrom, resulting in CO₂-lean absorbent that may form some or all of the CO₂-lean absorbent stream (110).

The CO₂ absorption contact region (108) outputs a CO₂-lean flue gas stream (132). The CO₂-lean flue gas stream (132) may still include some CO₂, but at a lower concentration than the CO₂-rich flue gas stream (104). For example, the CO₂-lean flue gas stream (132) may contain no more than about 2 vol % CO₂.

Due to reaction conditions needed to facilitate removal of CO₂ from the CO₂-rich flue gas stream (104) using the CO₂-lean absorbent stream (110), one or more VOCs from the CO₂-lean absorbent stream (110) may be vaporized into the CO₂-lean flue gas stream (132) output from the CO₂ absorption contact region (108). Example VOCs include main solvent components, such as the constituents of open-source solvents (e.g., ethanolamine, methyldiethanolamine, piperazine, aminomethylpropanol, diglycolamine, etc.). VOCs may also be trace components from solvent manufacturing (e.g., diethanolamine, 2-methylpiperazine, etc.). VOCs may also be formed within the carbon capture process and subsequently removed in the VOC control wash(es) (e.g., methylamine, n-nitrosopiperazine, etc.). The foregoing VOCs are not exclusive of VOCs that may be controlled using the teachings of the present disclosure.

The absorber column (102) may include one or more VOC control washes, collectively illustrated as a VOC control wash (112), for removing VOCs from the CO₂-lean flue gas stream (132) output from the CO₂ absorption contact region (108). When more than one VOC control wash is implemented, the VOC control washes may be implemented in series within the absorber column 102.

The CO₂-lean flue gas stream (132) enters (e.g., a bottom portion of) and travels (e.g., vertically upward) through the VOC control wash (112). Feed solution (114) is provided to (e.g., a top portion of) the VOC control wash (112). The feed solution (114) may include water and/or one or more acids (e.g., nitric and/or sulfuric acid). As the feed solution (114) moves (e.g., vertically downward) through the VOC control wash (112) and the CO₂-lean flue gas stream (132) simultaneously moves (e.g., vertically upward) through the feed solution (114), the feed solution (114) absorbs one or more VOCs in the CO₂-lean flue gas stream (132).

In some embodiments, the VOC control wash (112) may output a CO₂-lean flue gas stream (116) that is provided to the atmosphere.

In other embodiments, the CO₂-lean flue gas stream (116) may be input to a water wash (118).

As part of the reaction of the CO₂-lean absorbent stream (110) with the CO₂-rich flue gas stream (104), water vapor is released within the CO₂ absorption contact region (108) and travels (e.g., vertically upward) into the water wash (118). The CO₂-lean flue gas stream (116) containing the released water vapor enters a bottom portion of and travels (e.g., vertically upward) through the water wash (118). The water wash (118) may be implemented to condense the released water vapor in the CO₂-lean flue gas stream (116) and restore the water balance of the system. It may further result in removal of VOCs from the CO₂-lean flue gas stream (116) that is output from the VOC control wash (112)/absorber column (102). Feed water (120) may also be provided to a top portion of the water wash (118) to restore all or some portion of the water balance in lieu of condensing the released water vapor. As the feed water (120) moves (e.g., vertically downward) through the water wash (118) and the CO₂-lean flue gas stream (116) simultaneously moves (e.g., vertically upward) through the water wash (118), the CO₂ lean flue gas stream (116) contacts the feed water (120), and the feed water (120) absorbs one or more (e.g., water soluble) VOCs from the CO₂-lean flue gas stream (116).

The water wash (118) may output a CO₂-lean flue gas stream (122) that is provided to the atmosphere.

### VOC Control Wash Packing

In embodiments of the present disclosure, the VOC control wash (112) has a wire gauze packing.

As used herein, “wire gauze packing” refers to a structured packing having wire mesh pieces pressed into corrugation. Wire gauze packing can be made of various metal wires, such as stainless steel wire, monel wire, copper wire, and other metal wires that can be woven into wire gauze. Wire gauze packing has high effectiveness, a large flow rate and a low pressure drop. Wire gauze packing offers high separation efficiency at small liquid loads as wire gauze packing has a large number of theoretical stages in a low overall height.

Nonlimiting examples of wire gauze packing that are suitable for use in accordance with the present disclosure include AMBMESH (Ambani Metals, India) and BX HC® (Koch-Glitsch, USA) wire gauze packing.

### VOC Control Wash Recirculation Rates

As the feed solution (114) contacts the CO₂-lean flue gas stream (132) in the VOC control wash (112), the solution becomes process solution (124), which is output from the VOC control wash (112). The process solution (124) may be split into two streams, one that is fed into the absorber column (102) below the VOC control wash(es) (112) [e.g., above the CO₂ absorption contact region (108)] and one that is fed to a combiner (126). The portion of the process solution (124) that is fed to the combiner (126) may be referred to as a “recirculated portion” of the feed solution (114), as it may be used to form a portion of the feed solution (114) provided to the VOC control wash (112).

In some embodiments, the purpose of including a recirculated portion in the feed solution (114) is to ensure the feed solution (114) includes at least a threshold amount of amine.

One or more other streams [sometimes referred to herein as a “non-recirculated portion” of the feed solution (114)] may also be fed into the combiner (126). For example, the process water (128) and/or feed fluid (130) may be input to the combiner 126 as the non-recirculating portion of the feed solution (114). The feed fluid (130) may include water and/or one or more acids (e.g., nitric and/or sulfuric acid).

While FIG. 1 illustrates the non-recirculated portion being the process water (128) from the water wash (118) and/or the feed fluid (130), the present disclosure is not so limited. For example, in some embodiments [e.g., when the carbon capture system (100) does not include the water wash (118)] the non-recirculated portion of the feed solution (114) may originate from a direct contact cooler, a stripper, reflux from one or more regenerators, or some other fluid stream (e.g., a demineralized water stream).

“Recirculation rate,” when used with respect to the VOC control wash (112), refers to the ratio of the gpm of the recirculated portion [of the process solution (124)] to the other water stream (i.e., non-recirculated portion) input to the combiner (126).

In some embodiments, the recirculated portion is provided to the combiner (126) at a lower gpm than the other water stream (i.e., non-recirculated portion). In other words, some embodiments involve a low recirculation rate.

In some embodiments, the ratio of the recirculated portion to the non-recirculated portion may be in the range of 1:100 to 1:1 gpm:gpm. For example, in such embodiments the ratio of the recirculated portion to the non-recirculated portion may be 1:100, 1:99, 1:98, 1:97, . . . 1:90, 1:89, 1:88, 1:87, . . . 1:80, 1:79, 1:78, 1:77, . . . 1:70, 1:69, 1:68, 1:67, . . . 1:60, 1:59, 1:58, 1:57, . . . 1:50, 1:49, 1:48, 1:47, . . . 1:40, 1:39, 1:38, 1:37, . . . 1:30, 1:29, 1:28, 1:27, . . . 1:20, 1:19, 1:18, 1:17, . . . 1:10, 1:9, 1:8, 1:7, 1:6, 1:5, 1:4, 1:3, 1:2, or 1:1 gpm:gpm.

In some embodiments, the ratio of the recirculated portion to the non-recirculated portion may be in the range of 1:20 to 1:5 gpm:gpm. For example, in such embodiments the ratio of the recirculated portion to the non-recirculated portion may be 1:20, 1:19, 1:18, 1:17, 1:16, 1:15, 1:14, 1:13, 1:12, 1:11, 1:10, 1:9, 1:8, 1:7, 1:6, or 1:5 gpm:gpm.

In some embodiments, the ratio of the recirculated portion to the non-recirculated portion may be in the range of 1:10 to 1:5 gpm:gpm. For example, in such embodiments the ratio of the recirculated portion to the non-recirculated portion may be 1:10, 1:9, 1:8, 1:7, 1:6, or 1:5 gpm:gpm.

In some embodiments, the ratio of the recirculated portion to the non-recirculated portion may be no more than 1:5 gpm:gpm. For example, in such embodiments the ratio of the recirculated portion to the non-recirculated portion may be 1:5, 1:6, 1:7, 1:8 gpm:gpm, etc.

In some embodiments, the ratio of the recirculated portion to the non-recirculated portion may be no more than 1:10 gpm:gpm. For example, in such embodiments the ratio of the recirculated portion to the non-recirculated portion may be 1:10, 1:11, 1:12, 1:13 gpm:gpm, etc.

As the present disclosure envisions utilization of one or more VOC control washes (112), the present disclosure also envisions recirculation occurring with respect to one or more VOC control washes. For example, the carbon capture system (100) may include a single VOC control wash and recirculation may be performed with respect to the single VOC control wash. For further example, the carbon capture system (100) may include two or more VOC control washes and recirculation may be performed with respect to the entirety of the two or more VOC control washes. As another example, the carbon capture system (100) may include a two or more VOC control washes and recirculation may be performed with respect to less than all of the two or more VOC control washes (i.e., at least one of the VOC control washes may not receive any recirculated fluid).

### VOC Control Wash Feed Water Rate

The feed solution (114) may be input to the VOC control wash (112) at different rates. In some embodiments, it may be beneficial for the feed water to be input to the VOC control wash (112) at a rate that produces a “low liquid wetted rate.”

In some embodiments, the feed solution (114) may be input to the VOC control wash (112) at a rate of no more than 1.5 gpm/ft². For example, in such embodiments the feed solution (114) may be input to the VOC control wash (112) at a rate of 1.5, 1.4, 1.3, 1.2, 1.1, 1.0, 0.9, 0.8, 0.7, 0.6, 0.5, 0.4, 0.3, 0.2, or 0.1 gpm/ft².

In some embodiments, the feed solution (114) may be input to the VOC control wash (112) at a rate of no more than 1.0 gpm/ft². For example, in such embodiments the feed solution (114) may be input to the VOC control wash (112) at a rate of 1.0, 0.9, 0.8, 0.7, 0.6, 0.5, 0.4, 0.3, 0.2, or 0.1 gpm/ft².

In some embodiments, the feed solution (114) may be input to the VOC control wash (112) at a rate of no more than 0.4 gpm/ft². For example, in such embodiments the feed solution (114) may be input to the VOC control wash (112) at a rate of 0.4, 0.3, 0.2, or 0.1 gpm/ft².

In some embodiments, the feed solution (114) may be input to the VOC control wash (112) at a rate in the range of 0.02 to 1.5 gpm/ft². For example, in such embodiments the feed solution (114) may be input to the VOC control wash (112) at a rate of 0.02, 0.03, 0.04, . . . 0.10, 0.11, 0.12, 0.13, 0.14, . . . 0.20, 0.21, 0.22, 0.23, 0.24, . . . 0.30, 0.31, 0.32, 0.33, 0.34, . . . 0.40, 0.41, 0.42, 0.43, 0.44, . . . 0.50, 0.51, 0.52, 0.53, 0.54, . . . 0.60, 0.61, 0.62, 0.63, 0.64, . . . 0.70, 0.71, 0.72, 0.73, 0.74, . . . 0.80, 0.81, 0.82, 0.83, 0.84, . . . 0.90, 0.91, 0.92, 0.93, 0.94, . . . 1.00, 1.01, 1.02, 1.03, 1.04, . . . 1.10, 1.11, 1.12, 1.13, 1.14, . . . 1.20, 1.21, 1.22, 1.23, 1.24, . . . 1.30, 1.31, 1.32, 1.33, 1.34, . . . 1.40, 1.41, 1.42, 1.43, 1.44, . . . 1.50 gpm/ft².

In some embodiments, the feed solution (114) may be input to the VOC control wash (112) at a rate in the range of 0.1 to 1.0 gpm/ft². For example, in such embodiments the feed solution (114) may be input to the VOC control wash (112) at a rate of 0.1, 0.2, 0.3, 0.4, 0.5, 0.6, 0.7, 0.8, 0.9, or 1.0 gpm/ft².

In some embodiments, the feed solution (114) may be input to the VOC control wash (112) at a rate in the range of 0.1 to 1.5 gpm/ft². For example, in such embodiments the feed solution (114) may be input to the VOC control wash (112) at a rate of 0.1, 0.2, 0.3, 0.4, 0.5, 0.6, 0.7, 0.8, 0.9, 1.0, 1.1, 1.2, 1.3, 1.4, or 1.5 gpm/ft².

In some embodiments, the feed solution (114) may be input to the VOC control wash (112) at a rate in the range of 0.05 to 0.4 gpm/ft². For example, in such embodiments the feed solution (114) may be input to the VOC control wash (112) at a rate of 0.05, 0.06, 0.07, 0.08, 0.09, 0.10, 0.11, 0.12, 0.13, . . . 0.20, 0.21, 0.22, 0.23, . . . 0.30, 0.31, 0.32, 0.33, . . . or 0.40 gpm/ft².

### VOC Control Wash Flue Gas Stream Input Rate

The CO₂-lean flue gas stream (132) may be input to the VOC control wash (112) at different rates. In some embodiments, it may be beneficial for the CO₂-lean flue gas stream (132) to be input to the VOC control wash (112) at a “high” load factor. The load factor may be a superficial gas velocity equal to vapor velocity multiplied by the square root of the vapor density. The foregoing load factor is a key parameter used in column design to assess the potential for liquid flooding within the column, essentially indicating the maximum vapor flow rate that can be achieved before excessive liquid buildup occurs.

In some embodiments, the CO₂-lean flue gas stream (132) may be input to the VOC control wash (112) at a “high” load factor of not more than

$$4. ( \frac{ft}{s} ) {( \frac{lb}{{ft}^{3}} )}^{0.5} .$$

In some embodiments, the CO₂-lean flue gas stream (132) may be input to the VOC control wash (112) at a “high” load factor in a range of

$$1. to 4. ( \frac{ft}{s} ) {( \frac{lb}{{ft}^{3}} )}^{0.5} .$$

For example, the CO₂-lean flue gas stream (132) may be input to the VOC control wash (112) at a load factor of 1.0, 1.1, 1.2, 1.3, . . . 2.0, 2.1, 2.2, 2.3, . . . 3.0, 3.1, 3.2, 3.3, . . . or

$$4. ( \frac{ft}{s} ) {( \frac{lb}{{ft}^{3}} )}^{0.5} .$$

### EXAMPLES

### Example 1. Pilot Testing

Pilot testing was conducted using a carbon capture system including a VOC control wash and water wash, like illustrated in FIG. 1. Flue gas was input to the absorber at a substantially constant load factor and varying temperatures. The recirculation rate of the feed water input to the VOC control wash was varied. Regardless of load factor and temperature, the system was configured to capture 96% of CO₂ from the flue gas. Testing was performed using commercially available sheet metal structured packing and wire gauzing packing in the VOC control wash.

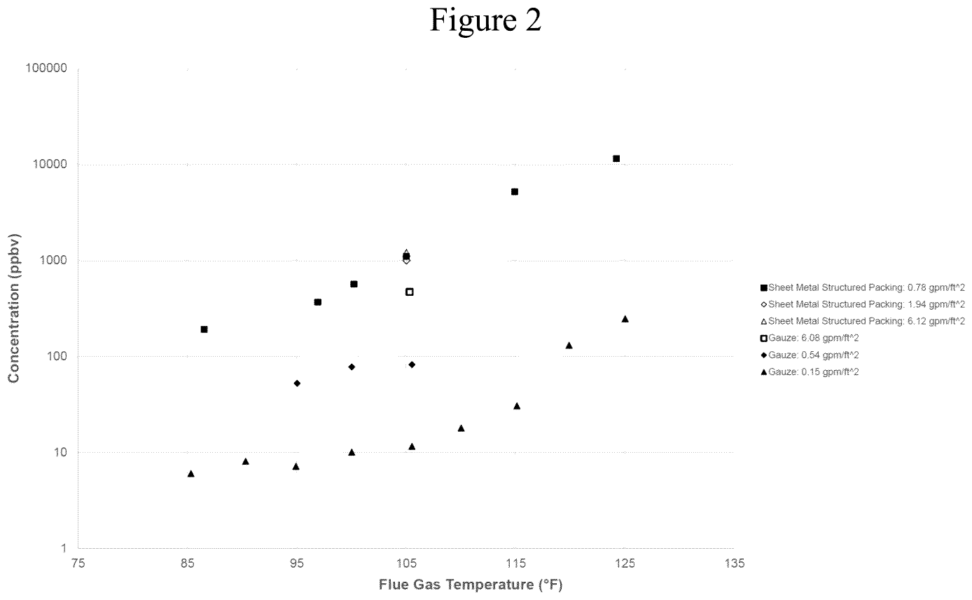

FIG. 2 shows the measured emissions for a particular CO₂ absorbent component. As can be seen, when the commercially available sheet metal structured packing was used, the emissions were approximately 1000 ppbv, regardless of recirculation rate, at a flue gas temperature of 105 °F. However, with wire gauze packing, emissions of the CO₂ absorbent component decreased with decreasing recirculation rates, reaching approximately 10 ppbv with low recirculation. Based on the data collected, wire gauze packing demonstrated better wetting than the commercially available sheet metal structured packing.

Although the commercially available sheet metal structured packing is intended to perform at low wetted rates, it was hypothesized that the combination of low wetted rates and high flue gas load factor leads to gas maldistribution, which results in poor mass transfer performance in the packing bed.

### FURTHER DEFINITIONS AND CONSTRUCTION OF TERMS

The titles, headings, and subheadings provided herein should not be interpreted as limiting the various aspects of the disclosure. Accordingly, the terms defined herein are more fully defined by reference to the specification in its entirety. All references cited herein are incorporated by reference in their entirety.

Unless otherwise defined, scientific and technical terms used herein shall have the meanings that are commonly understood by those of ordinary skill in the art. Further, unless otherwise required by context, singular terms shall include pluralities, and plural terms shall include the singular.

In this application, the use of “or” means “and/or” unless stated otherwise. In the context of a multiple dependent claim, the use of “or” refers back to more than one preceding independent or dependent claim in the alternative only.

It is further noted that, as used in this specification and the appended claims, the singular forms “a,” “an,” and “the,” and any singular use of any word, include plural referents unless expressly and unequivocally limited to one referent.

As used herein, the term “about,” means approximately. When the term “about” is used in conjunction with a numerical range, it modifies that range by extending the boundaries above and below the numerical values set forth. Illustratively, the use of the term “about” indicates that values slightly outside the cited values (i.e., plus or minus 0.1% to 10%), which are also effective and safe are included in the value. Numerical ranges recited herein by endpoints include all numbers and fractions subsumed within that range (e.g. 1 to 5 includes 1, 1.5, 2, 2.75, 3, 3.90, 4, and 5).

As used herein, the terms “comprising” (and any form of comprising, such as “comprise,” “comprises,” and “comprised”), “having” (and any form of having, such as “have” and “has”), “including” (and any form of including, such as “includes” and “include”), and “containing” (and any form of containing, such as “contains” and “contain”) are inclusive or open-ended and do not exclude additional, un-recited elements or method steps. Additionally, a term that is used in conjunction with the term “comprising” is also understood to be able to be used in conjunction with the term “consisting of” or “consisting essentially of.”

Method steps described in this disclosure can be performed in any order unless otherwise indicated or otherwise clearly contradicted by context.

For the avoidance of doubt, insofar as is practicable any embodiment of a given aspect of the present disclosure may occur in combination with any other embodiment of the same aspect of the present disclosure. In addition, insofar as is practicable it is to be understood that any preferred or optional embodiment of any aspect of the present disclosure should also be considered as a preferred or optional embodiment of any other aspect of the present disclosure.

What is claimed is:

1. A method for treating a flue gas stream, comprising:
contacting a CO₂-rich flue gas stream with a CO₂ absorbent to produce a CO₂-lean flue gas stream;
passing the CO₂-lean flue gas stream through a wire gauze packing of a volatile organic compound (VOC) control wash at a flue gas load factor in a range of 1.0 to 4.0 (ft/s) (lb/ft³)^{0.5}; and
inputting feed solution to the VOC control wash at a rate of no more than 1.5 gpm/ft², wherein the feed solution comprises a recirculated portion and a non-recirculated portion, the recirculated portion being a portion of process solution output from the VOC control wash.

2. The method of claim 1, further comprising inputting the feed solution at a rate of no more than 1.0 gpm/ft².

3. The method of claim 2, further comprising inputting the feed solution at a rate of no more than 0.4 gpm/ft².

4. The method of claim 1, further comprising inputting the feed solution at a rate in the range of 0.02 to 1.5 gpm/ft².

5. The method of claim 1, further comprising inputting the feed solution at a rate in the range of 0.1 to 1.0 gpm/ft².

6. The method of claim 1, further comprising inputting the feed solution at a rate in the range of 0.05 to 0.4 gpm/ft².

7. The method of claim 1, further comprising producing the feed solution by combining the recirculated portion with the non-recirculated portion, wherein the combining comprises providing the recirculated portion at a lower gpm than the non-recirculated portion.

8. The method of claim 7, further comprising producing the feed solution to have a ratio of the recirculated portion to the non-recirculated portion in the range of 1:100 to 1:1 gpm:gpm.

9. The method of claim 8, further comprising producing the feed solution to have a ratio of the recirculated portion to the non-recirculated portion in the range of 1:20 to 1:5 gpm:gpm.

10. The method of claim 7, further comprising producing the feed solution to have a ratio of the recirculated portion to the non-recirculated portion of no more than 1:10 gpm:gpm.

11. The method of claim 1, further comprising producing the non-recirculated portion from water output from a water wash.

12. The method of claim 1, further comprising inputting, to a water wash, CO₂-lean flue gas stream output from the VOC control wash.

13. A system for treating a flue gas stream, comprising a volatile organic compound (VOC) control wash that:
comprises a wire gauze packing;
receives a CO₂-lean flue gas stream at a flue gas load factor in a range of
$$1. to 4. ( \frac{ft}{s} ) {( \frac{lb}{{ft}^{3}} )}^{0.5} ,$$
wherein the CO₂-lean flue gas stream is produced from contacting a CO₂-rich flue gas stream with a CO₂ absorbent; and
receives feed solution at a rate of no more than 1.5 gpm/ft², wherein the feed solution comprises a recirculated portion and a non-recirculated portion, the recirculated portion being a portion of process solution output from the VOC control wash.

14. The system of claim 13, wherein the VOC control wash receives the feed solution at a rate of no more than 1.0 gpm/ft².

15. The system of claim 14, wherein the VOC control wash receives the feed solution at a rate of no more than 0.4 gpm/ft².

16. The system of claim 13, wherein the VOC control wash receives the feed solution at a rate in the range of 0.02 to 1.5 gpm/ft².

17. The system of claim 13, wherein the VOC control wash receives the feed solution at a rate in the range of 0.1 to 1.0 gpm/ft².

18. The system of claim 13, wherein the VOC control wash receives the feed solution at a rate in the range of 0.05 to 0.4 gpm/ft².

19. The system of claim 13, wherein the recirculated portion is provided at a lower gpm than the non-recirculated portion.

20. The system of claim 19, wherein a ratio of the recirculated portion to the non-recirculated portion is in the range of 1:100 to 1:1 gpm:gpm.

21. The system of claim 20, wherein the ratio of the recirculated portion to the non-recirculated portion is in the range of 1:20 to 1:5 gpm:gpm.

22. The system of claim 19, wherein a ratio of the recirculated portion to the non-recirculated portion is no more than 1:10 gpm:gpm.

23. The system of claim 13, further comprising a water wash that outputs the non-recirculated portion of the feed solution.

24. The system of claim 13, further comprising a water wash that receives CO₂-lean flue gas stream output from the VOC control wash.

25. A volatile organic compound (VOC) control wash of a system for treating a flue gas stream, the VOC control wash comprising:
a wire gauze packing;
a first inlet that receives a CO₂-lean flue gas stream at a flue gas load factor in a range of
$$1. to 4. ( \frac{ft}{s} ) {( \frac{lb}{{ft}^{3}} )}^{0.5} ,$$
wherein the CO₂-lean flue gas stream is produced from contacting a CO₂-rich flue gas stream with a CO₂ absorbent;
a second inlet that receives feed solution at a rate of no more than 1.5 gpm/ft², wherein the feed solution comprises a recirculated portion and a non-recirculated portion; and
an outlet through which process solution is output from the VOC control wash, wherein at least a portion of the process solution forms the recirculated portion.

26. The VOC control wash of claim 25, wherein the second inlet receives the feed solution at a rate of no more than 1.0 gpm/ft².

27. The VOC control wash of claim 26, wherein the second inlet receives the feed solution at a rate of no more than 0.4 gpm/ft².

28. The VOC control wash of claim 25, wherein the second inlet receives the feed solution at a rate in the range of 0.02 to 1.5 gpm/ft².

29. The VOC control wash of claim 25, wherein the second inlet receives the feed solution at a rate of 0.1 to 1.0 gpm/ft².

30. The VOC control wash of claim 25, wherein the second inlet receives the feed solution at a rate in the range of 0.05 to 0.4 gpm/ft².

31. The VOC control wash of claim 25, wherein the recirculated portion is provided at a lower gpm than the non-recirculated portion.

32. The VOC control wash of claim 31, wherein a ratio of the recirculated portion to the non-recirculated portion is in the range of 1:100 to 1:1 gpm:gpm.

33. The VOC control wash of claim 32, wherein the ratio of the recirculated portion to the non-recirculated portion is in the range of 1:20 to 1:5 gpm:gpm.

34. The VOC control wash of claim 31, wherein a ratio of the recirculated portion to the non-recirculated portion is no more than 1:10 gpm:gpm.

35. The VOC control wash of claim 25, wherein the non-recirculated portion is formed from process water output from a water wash.
